(19) United States
(12) Patent Application Publication
(10) Pub. No.: US 2023/0276728 A1
(43) Pub. Date: Sep. 7, 2023

(54) MECHANISM AND TECHNOLOGY FOR INHIBITING METHANE PRODUCTION IN PADDY

(71) Applicant: FENG SHENG YUAN, KEELUNG CITY (TW)

(72) Inventor: FENG SHENG YUAN, KEELUNG CITY (TW)

(21) Appl. No.: 17/851,501

(22) Filed: Jun. 28, 2022

(30) Foreign Application Priority Data
Mar. 2, 2022 (TW) 111107611

(51) Int. Cl. A01B 79/00

(52) U.S. Cl. CPC A01B 79/00

(57) ABSTRACT

A mechanism and technology for inhibiting methane production in paddy, which mixes the oscillating magnet composition with a weight ratio of 400 to 500 kilograms per 666 square meters into the soil of the paddy, so as to increase the dissolved oxygen in the soil, to inhibit the generation of methanogens, and then reduce the amount of methane production; wherein, the composition weight percentage of the oscillating magnet composition includes 72%˜82% far-infrared natural mineral base material, 10%˜18% biochar, 2%˜5% seaweed element and activated water agent composed of 3%˜5% of a natural ore; the far-infrared natural mineral base material can emit far-infrared rays, make the water molecules cluster smaller, and the smaller water molecules are easier to penetrate the biofilm.

### BACKGROUND OF THE INVENTION

### 1. Field of the Invention

The invention relates to a composition, especially the one that mixed into the soil of paddy, it can make the soil emit far-infrared rays so that dissolved oxygen can penetrate the biofilm quickly, so as to inhibit the production of methanogens, which is a mechanism and technology for inhibiting the production of methane in paddy.

### 2. Description of the Related Art

In addition to carbon dioxide, the greenhouse gas that has the greatest impact on global warming is methane; methane (CH₄) is commonly known as biogas, and its ability to capture heat in the atmosphere is 25 times that of carbon dioxide; and according to the UNFCCC to promote carbon neutrality and zero discharge requirements, the reduction and control of greenhouse gases including methane, are bound to be subject to extremely strict attention and scrutiny; in addition, a major source of methane emitted into the atmosphere is modern industries such as oil and natural gas. Another major source is farming, landfill waste, and livestock exhaust. The reason for the production of methane, as shown in FIG. 1, is that a large amount of organic matter is in an anaerobic (anoxic) state for a long time, resulting in the massive production and reproduction of “methanogens” in this environment. Methanogens produce large amounts of methane when they metabolize and decompose organic matter.

In agriculture and animal husbandry, Oryza sativa is an important source of methane emissions; since rice is one of the world's main food crops, it is planted in a large area; and Oryza sativa uses photosynthesis to convert carbon dioxide into sucrose, and then transmit it to the roots, as FIG. 2 showing; the roots 11 of the Oryza sativa 10 are deeply planted in the soil 20, and the soil surface is submerged in shallow water 30 to isolate the air. Since the shallow water 30 is in a static state, there will be microbial strains near the roots 11 of the Oryza sativa 10. Metabolic decomposition of the organic matter conserved in the roots 11 causes the dissolved oxygen (DO) in the local space to decrease, and because the dissolved oxygen in the surrounding soil 20 is not easily diffused into the space, a biofilm 40 will be formed on the periphery of the local space, and its interior becomes a completely anaerobic state with a dissolved oxygen content of 0 mg/L; at this time, “methanogens” become the dominant bacterial species, which will drive the massive production of methane and emit into the atmosphere.

At present, many research schemes try to let the shallow water that floods the paddy flow, or take regular drainage measures to avoid the formation of anaerobic state in the local space in the soil, so as to reduce the generation of methane in the paddy: however, let the shallow water flow or regular drainage is limited by environmental conditions and will affect the growth efficiency of rice, so it is not easy to be accepted by cultivators; so how to apply far-infrared natural mineral base material to increase the amount of dissolved oxygen in the local space in the soil, thereby avoiding soil to become the anaerobic state is a subject that the inventors of the present invention.

### SUMMARY OF THE INVENTION

It is a primary objective of the present invention to provide a mechanism and technology for inhibiting methane production in paddy is to provide a composition with far-infrared natural mineral base material, which is mixed into the soil of paddy, let the soil emit far-infrared rays so that dissolved oxygen can quickly penetrate the biofilm, so as to inhibit the generation and reproduction of “methanogens”.

In order to achieve the above objectives, the present invention comprise: mixes the oscillating magnet composition with a weight ratio of 400 to 500 kilograms per 666 square meters into the soil of the paddy, so as to increase the dissolved oxygen in the local space of the residual organic matter in the soil, to inhibit the generation and reproduction of methanogens, and then reduce the amount of methane production; wherein, the composition weight percentage of the oscillating magnet composition includes 72%˜82% far-infrared natural mineral base material, 10%˜18% biochar, 2%˜5% seaweed element and activated water agent composed of 3%˜5% of a natural ore; wherein the far-infrared natural mineral base material can continuously and stably emit far-infrared rays, make the water molecules cluster in the soil become smaller, and the smaller water molecules are easier to penetrate the biofilm and facilitate diffusion; The CO2 metabolized by organic matter is adsorbed on the surface of the biochar to reduce the concentration of CO2 in water molecules, thereby reducing the amount of methane produced by methanogens; The seaweed element is used for granulation and shaping, because it disintegrates when it encounters water, which can achieve the effect of inhibiting specific bacteria; the activated water agent composed of a natural ore, its main components contain trace elements including BaO, Cr₂O₃, CaCO₃, P₂O₅, Na₂O, MnO, CaO, Cu, etc., it is used for increasing the amount of dissolved oxygen in water molecules.

The activated water agent is composed of a natural ore, it has a porous honeycomb shape and has the function of increasing the amount of dissolved oxygen in the water. Its mechanism and principle are as follows:
a. The active water agent is a natural ore. After a high temperature process in nature, it will continue to emit far infrared rays to make the water molecules cluster smaller, which will facilitate the diffusion of oxygen into water and dissolved oxygen.
b. The appearance of the active water agent is in the shape of a porous honeycomb. When the water flows through, it has the functions of dispersing the water flow and breaking up the water flow, which will increase the surface area of the contact between oxygen and water molecules, thereby increasing the dissolved oxygen speed and dissolved oxygen amount.
c. The active water agent has a water purification mechanism, which can remove pollutants in water, organic nitrogen (nitrogen in the form of organic matter, such as urea) and ammonia nitrogen (nitrogen in the form of ammonia, including NH₄+ and NH₃); The first step is nitrification, which is oxidizing organic nitrogen and ammonia nitrogen into nitrate, and the second step is denitrification, which is reducing nitrate into completely harmless nitrogen (chemical equation is as follows):

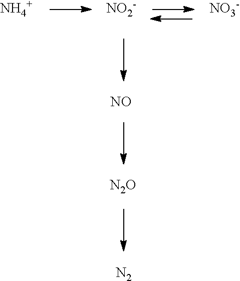

Since the active water agent is a natural ore, and the porous honeycomb shape makes its surface an excellent environment for “nitrifying bacteria” and “denitrifying bacteria” to attach and grow, the active water agent is conducive to removing organic nitrogen and ammonia nitrogen in water. Eutrophication can be avoided, and the amount of dissolved oxygen in the water can be increased at the same time.

Also, the composition and weight percentage of the far-infrared natural mineral base material are: silicon dioxide (SiO₂) 42˜52%, iron oxide (Fe₂O₃) 11˜13%, manganese dioxide (MnO₂) 4˜7%, calcium oxide (CaO) 2˜4%, zirconium dioxide (ZrO₂) 2˜4%, alumina (Al₂O₃) 2˜4%, zinc oxide (ZnO) 1˜3%, potassium oxide (K₂O) 3˜4%, magnesium oxide (MgO) 1˜3%, cobalt oxide (CoO) 1˜4%, pulverized fuel ash 9˜13%, coal powder 5%, titanium dioxide (TiO₂) 1˜2%, cerium oxide (CeO₂) 0.5˜0.8%, and lanthanum oxide (La₂O₃) 0.1˜0.5%; and make its far-infrared radiation rate reach the characteristic value of more than 87.9%.

With the features disclosed above the mechanism and technology for inhibiting methane production in paddy make continuously and stably emit far-infrared oscillating magnet compositions be mixed with a weight ratio of 400 to 500 kilograms per 666 square meters into the soil of the paddy before replanting, so that it can continue to radiate the far-infrared rays in the soil of the paddy, make the water molecules in the soil resonate to make the water molecules cluster smaller, and the small water molecules can make the dissolved oxygen penetrate more quickly into the biofilm formed by the metabolism of organic matter in the soil, thereby improving the dissolved oxygen (DO) in the local space of residual organic matter in the soil to prevent the soil from forming an anaerobic state, and achieves the inhibition of the generation and reproduction of “methanogens”.

### BRIEF DESCRIPTION OF THE DRAWINGS

FIG. 1 is a block diagram illustrating the reproduction of the methanogens;

FIG. 2 is a schematic diagram illustrating the long-term anaerobic state of the biofilm in the paddy;

FIG. 3 is a block diagram illustrating the composition of the oscillating magnet of the present invention;

FIG. 4 is a block diagram illustrating the reproduction of the methanogens;

FIG. 5A is a schematic diagram illustrating the covalent bond structure between hydrogen and oxygen atoms;

FIG. 5B is a schematic diagram illustrating the water molecule polarity;

FIG. 5C is a schematic diagram illustrating the water molecule polarity;

FIG. 5D is a schematic diagram illustrating the water molecules cluster;

FIG. 5E is a schematic diagram illustrating the water molecules cluster go through the hole of the film;

FIG. 6A is a schematic diagram illustrating the photomicrographs of the far-infrared natural mineral base material;

FIG. 6B is a schematic diagram illustrating the photomicrographs of the far-infrared natural mineral base material;

FIG. 6C is a schematic diagram illustrating the photomicrographs of the far-infrared natural mineral base material;

FIG. 7 is a schematic diagram illustrating the dissolved oxygen water.

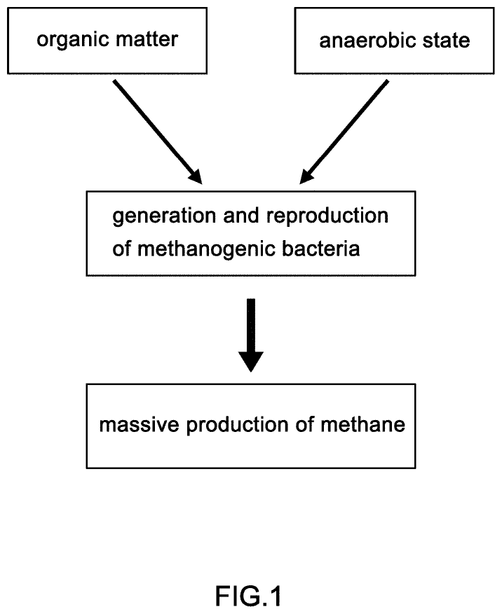

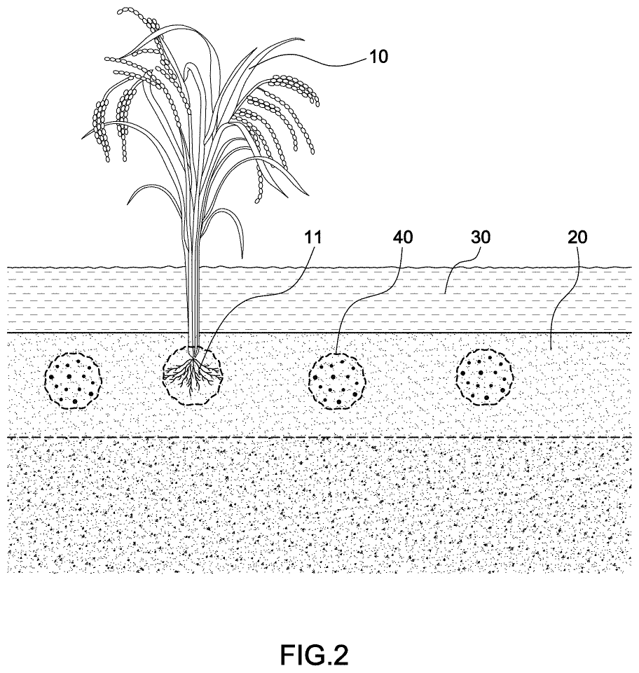

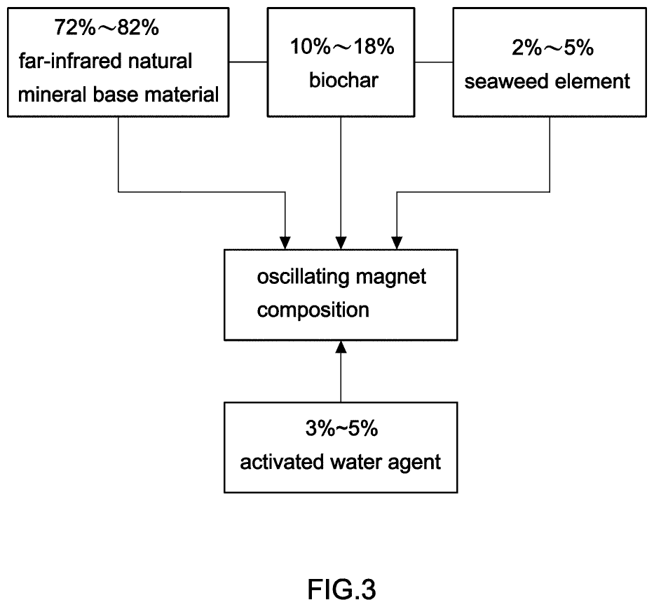

### DETAILED DESCRIPTION OF THE PREFERRED EMBODIMENT

First, the present invention comprise: mixes the oscillating magnet composition with a weight ratio of 400 to 500 kilograms per 666 square meters into the soil of the paddy, so as to increase the dissolved oxygen in the local space of the residual organic matter in the soil, to inhibit the generation and reproduction of methanogens, and then reduce the amount of methane production; wherein, the composition weight percentage of the oscillating magnet composition includes 72%˜82% far-infrared natural mineral base material, 10%˜18% biochar, 2%˜5% seaweed element and activated water agent composed of 3%˜5% of a natural ore; wherein the far-infrared natural mineral base material can continuously and stably emit far-infrared rays, make the water molecules cluster in the soil become smaller, and the smaller water molecules are easier to penetrate the biofilm and facilitate diffusion; the CO2 metabolized by organic matter is adsorbed on the surface of the biochar to reduce the concentration of CO2 in water molecules, thereby reducing the amount of methane produced by methanogens; The seaweed element is used for granulation and shaping, because it disintegrates when it encounters water, which can achieve the effect of inhibiting specific bacteria; the activated water agent composed of a natural ore, its main components contain trace elements including BaO, Cr₂O₃, CaCO₃, P₂O₅, Na₂O, MnO, CaO, Cu, etc., it is used for increasing the amount of dissolved oxygen in water molecules.

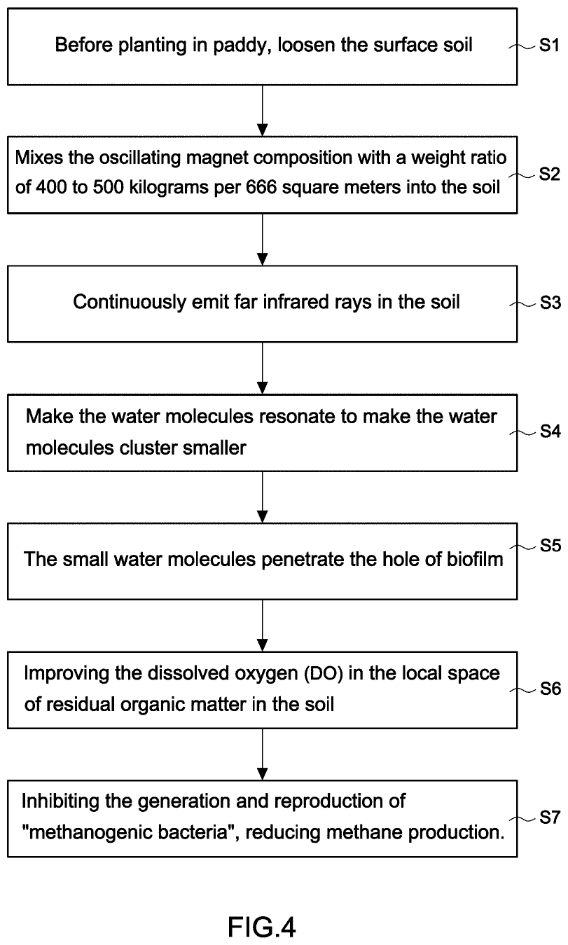

Referring to FIG. 4, the present invention having the process of inhibition of producing methane in paddy; including, S1: Before planting in paddy, loosen the surface soil; S2: Mixes the oscillating magnet composition with a weight ratio of 400 to 500 kilograms per 666 square meters into the soil; S3: Continuously emit far infrared rays in the soil; S4: Make the water molecules resonate to make the water molecules cluster smaller; S5: The small water molecules penetrate the hole of biofilm; S6: Improving the dissolved oxygen (DO) in the local space of residual organic matter in the soil; S7: Inhibiting the generation and reproduction of “methanogens”, reducing methane production.

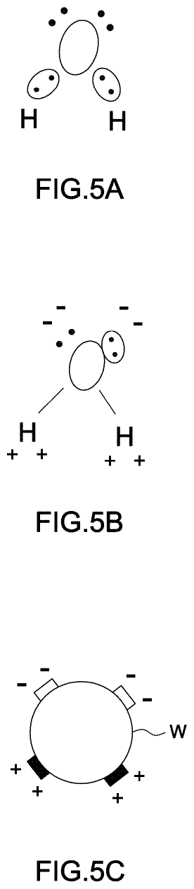

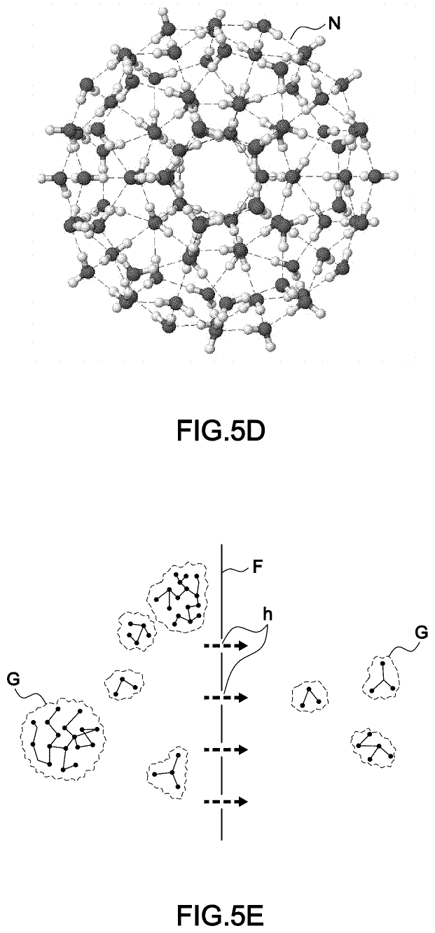

The far-infrared natural mineral base material of the present invention can continuously and stably emit far-infrared rays, make the water molecules cluster in the soil resonate to make the water molecules cluster smaller, and the smaller water molecules penetrate the biofilm and improve the dissolved oxygen (DO) in the local space of residual organic matter in the soil; the mechanism and principle are as follows: a water molecule is composed of one oxygen atom and two hydrogen atoms, and its chemical formula is H₂O; wherein, one oxygen atom has 8 electrons, including 2 electrons in the first orbital, and 6 electrons in the second orbital, and the outer orbital (the second orbital) must have 8 electrons to maintain its stable structure; a hydrogen atom only has 1 electron in its first orbital, and the outer orbital (the first layer) must have 2 electrons to maintain stability; therefore, between one oxygen atom and two hydrogen atoms, it is stabilized in the form of covalent bonds shared by electrons, and water molecules are formed accordingly, as showing in FIG. 5A; in addition to covalent bonds in water molecules, the unshared electron pair at the oxygen atom end will be negative electrification, while the hydrogen atom end will be positive electrification, as showing in FIG. 5B; the polarity of water molecules W is very similar to that of four magnets with different polarities attached to the four opposite corners of a ping pong ball, wherein, two are positive hydrogen atoms, and the other two are negative unshared electron pairs, as showing in FIG. 5C; in liquid water, water molecules attract each other like ping-pong balls attached to magnets and form cluster, this attraction is called hydrogen bond, and promotes the phenomenon that liquid water forms water molecules cluster, that is, from a few to several cluster, ten or even hundreds of water molecules form a large reticular structure N, as showing in FIG. 5D; because the microbial strains metabolize and decompose the organic matter contained in the roots of Oryza sativa to form a biofilm, and the surface of the biofilm is a film F full of fine holes h, the water molecules cluster G must pass through the fine holes h of the film F to enter the biofilm, and the smaller the water molecule cluster G, the easier it is for dissolved oxygen to pass through the film F, and the more the dissolved oxygen can diffuse into the biofilm to inhibit the generation of “methanogens”, as showing in FIG. 5E.

The composition and weight percentage of the far-infrared natural mineral base material of the present invention are: silicon dioxide (SiO₂) 42˜52%, iron oxide (Fe₂O₃) 11˜13%, manganese dioxide (MnO) 4˜7%, calcium oxide (CaO) 2˜4%, zirconium dioxide (ZrO₂) 2˜4%, alumina (Al₂O₃) 2˜4%, zinc oxide (ZnO) 1˜3%, potassium oxide (K₂O) 3˜4%, magnesium oxide (MgO) 1˜3%, cobalt oxide (CoO) 1˜4%, pulverized fuel ash 9˜13%, coal powder 5%, titanium dioxide (TiO₂) 1˜2%, cerium oxide (CeO₂) 0.5˜0.8%, and lanthanum oxide (La₂O₃) 0.1˜0.5%; and make its far-infrared radiation rate reach the characteristic value of more than 87.9%.

According to the experimental method in the present invention, the composition of the far-infrared natural mineral base material is combined into 10 groups of base materials of different proportions according to different weight percentages, and its far-infrared radiation rate is detected respectively, the percentage of each group composition and the data of its radiation rate are showing in Table below:

| | Group | | | | | | | | | |
|---|---|---|---|---|---|---|---|---|---|---|
| Composition | 1 | 2 | 3 | 4 | 5 | 6 | 7 | 8 | 9 | 10 |
| SiO₂ | 42 | 43 | 43 | 44 | 47 | 48 | 48 | 49 | 50 | 52 |
| Fe₂O₃ | 11.5 | 13 | 12 | 12.5 | 13 | 13 | 12.8 | 11.3 | 12 | 12.4 |
| MnO2 | 7 | 6.5 | 6 | 5.5 | 5.5 | 5 | 5 | 5.5 | 5 | 4.5 |
| CaO | 3 | 2.5 | 4 | 3 | 4 | 3 | 3 | 3 | 3 | 3 |
| ZrO₂ | 2.5 | 3 | 3 | 2.5 | 3 | 3 | 3.5 | 4 | 4 | 2.5 |
| Al₂O₃ | 2.5 | 2 | 2 | 3 | 3 | 3 | 4 | 3.2 | 3.2 | 3 |
| ZnO | 2 | 2 | 3 | 2.5 | 1.5 | 2 | 1.5 | 1 | 2 | 2 |
| K₂O | 3 | 3 | 4 | 4 | 3 | 3 | 3 | 3.5 | 3 | 3 |
| MgO | 3 | 3 | 2.5 | 2 | 2 | 1.5 | 1 | 1 | 1 | 1 |
| CoO | 3.5 | 3 | 2 | 2 | 1.5 | 1.5 | 1.5 | 1.2 | 1 | 1 |
| pulverized fuel ash | 13 | 12 | 11 | 11 | 9 | 10 | 10 | 10 | 9 | 9 |
| coal powder | 5 | 5 | 5 | 5 | 5 | 5 | 5 | 5 | 5 | 5 |
| titanium dioxide | 1 | 1 | 1.5 | 2 | 1.5 | 1 | 1 | 1.5 | 1 | 1 |
| CeO₂ | 0.7 | 0.7 | 0.7 | 0.5 | 0.6 | 0.8 | 0.6 | 0.7 | 0.5 | 0.5 |
| lanthanum oxide | 0.3 | 0.3 | 0.3 | 0.5 | 0.4 | 0.2 | 0.1 | 0.1 | 0.3 | 0.1 |
| radiation rate | 88.3 | 88.7 | 87.9 | 89.4 | 89.6 | 94.3 | 96.2 | 95.8 | 91.3 | 88.6 |

Through the comparison of the far-infrared radiation rate of each group, it can be known that the three groups with the best radiation rate are Group 6, Group 7, and Group 8; wherein the composition percentages and the radiation rate for Group 7 are: silicon dioxide (SiO₂) 48%, iron oxide (Fe₂O₃) 12.8%, manganese dioxide (MnO₂) 5%, calcium oxide (CaO) 3%, zirconium dioxide (ZrO₂) 3.5%, alumina (Al₂O₃) 4%, zinc oxide (ZnO) 1.5%, potassium oxide (K₂O) 3%, magnesium oxide (MgO) 1%, cobalt oxide (CoO) 1.5%, pulverized fuel ash 10%, coal powder 5%, titanium dioxide (TiO₂) 1%, cerium oxide (CeO₂) 0.6%, and lanthanum oxide (La₂O₃) 0.1%, and radiation rate 96.2%; the composition percentages and the radiation rate for Group 8 are: silicon dioxide (SiO₂) 49%, iron oxide (Fe₂O₃) 11.3%, manganese dioxide (MnO₂) 5.5%, calcium oxide (CaO) 3%, zirconium dioxide (ZrO₂) 4%, alumina (Al₂O₃) 3.2%, zinc oxide (ZnO) 1%, potassium oxide (K₂O) 3.5%, magnesium oxide (MgO) 1%, cobalt oxide (CoO) 1.2%, pulverized fuel ash 10%, coal powder 5%, titanium dioxide (TiO₂) 1.5%, cerium oxide (CeO₂) 0.7%, and lanthanum oxide (La₂O₃) 0.1%, and radiation rate 95.8%; the composition percentages and the radiation rate for Group 6 are: silicon dioxide (SiO₂) 48%, iron oxide (Fe₂O₃) 13%, manganese dioxide (MnO₂) 5%, calcium oxide (CaO) 3%, zirconium dioxide (ZrO₂) 3%, alumina (Al₂O₃) 3%, zinc oxide (ZnO) 2%, potassium oxide (K₂O) 3%, magnesium oxide (MgO) 1.5%, cobalt oxide (CoO) 1.5%, pulverized fuel ash 10%, coal powder 5%, titanium dioxide (TiO₂) 1%, cerium oxide (CeO₂) 0.8%, and lanthanum oxide (La₂O₃) 0.2%, and radiation rate 94.3%.

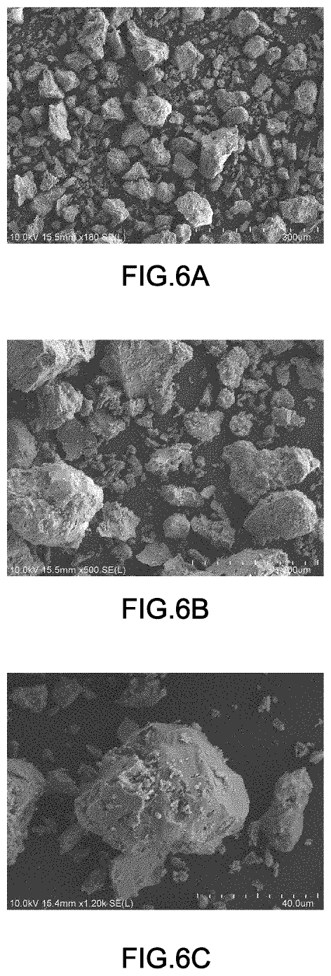

The far-infrared natural mineral base material in the present invention is a porous structure, and its pore diameter will reach the characteristic requirements of 0.2˜0.8 microns; moreover, the porous structure formed by the far-infrared natural mineral base material is showing in FIG. 6A for a photo magnified by a microscope of 180 times, the magnification of 500 times is showing in FIG. 6B, the magnification of 1200 times is showing in FIG. 6C, the pore structure showing in the photo has a pore size of 0.2 to 0.8 microns, and emit far-infrared rays with a wavelength of 8˜14 microns with nano-wave energy, because its frequency can just make water molecules resonate, and the hydrogen bonds can be broken by resonation to decompose the water molecules, and effectively promote the diffusion of the miniaturized oxygen-dissolved water molecules cluster into the biofilm.

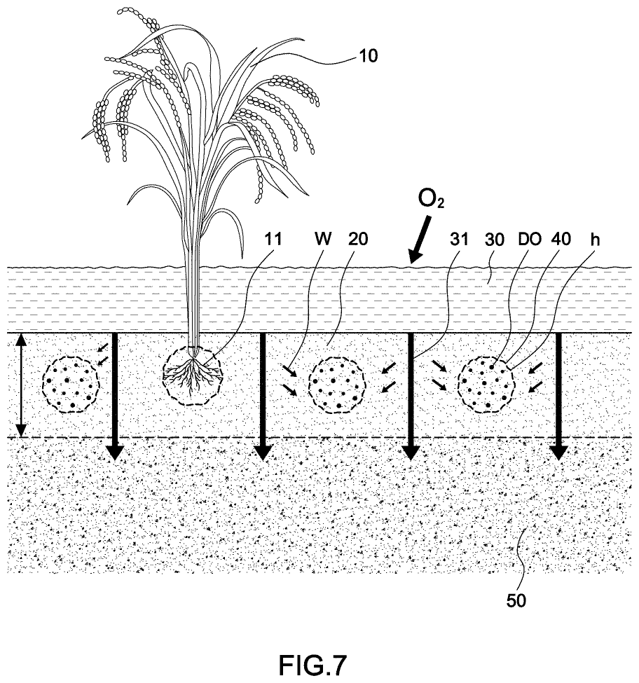

Referring to FIG. 7, showing the state that oxygen-dissolved water molecules cluster penetrate into the biofilm; since the growth of the Oryza sativa 10 is through photosynthesis, carbon dioxide is converted into sucrose and then sent to the roots 11; the roots 11 of the Oryza sativa 10 is deeply planted in soil 20, the soil surface is submerged with shallow water 30, and the surface of the shallow water 30 is in contact with the air, so oxygen O2 will dissolve into the water to form dissolved oxygen DO, and infiltrate into the soil 20 with the water molecules w of the water flow 31, or flow into the ground water zone 50; since the shallow water 30 is in a static state, there will be microbial strains near the roots 11 of the Oryza sativa 10. Metabolic decomposition of the organic matter conserved in the roots 11 causes the dissolved oxygen (DO) in the local space to decrease, and because the dissolved oxygen in the surrounding soil 20 is not easily diffused into the space, a biofilm 40 will be formed on the periphery of the local space, and its interior becomes a completely anaerobic state with a dissolved oxygen content of 0 mg/L; the present invention make continuously and stably emit far-infrared oscillating magnet compositions be mixed with a weight ratio of 400 to 500 kilograms per 666 square meters into the soil 20 of the paddy before replanting, so that it can continue to radiate the far-infrared rays in the soil 20 of the paddy, make the water molecules w in the soil 20 resonate to make the water molecules cluster G smaller, and the small oxygen-dissolved water molecules cluster G can penetrate more easily penetrate the hole h the biofilm 40, thereby improving the dissolved oxygen (DO) in the biofilm 40 to change the original anaerobic state, and achieves the inhibition of the generation and reproduction of “methanogens”.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mechanism and technology for inhibiting methane production in paddy, which mixes an oscillating magnet composition with a weight ratio of 400 to 500 kilograms per 666 square meters into the soil of the paddy, so as to increase the dissolved oxygen in the local space of the residual organic matter in the soil, to inhibit the generation and reproduction of methanogens, and then reduce the amount of methane production; wherein, the composition weight percentage of the oscillating magnet composition includes 72%˜82% a far-infrared natural mineral base material, 10%˜18% a biochar, 2%˜5% a seaweed element and an activated water agent composed of 3%˜5% of a natural ore.

2. The mechanism and technology for inhibiting methane production in paddy as claimed in claim 1, wherein the activated water agent composed of a natural ore, its main components contain trace elements including BaO, Cr₂O₃, CaCO₃, P₂O₅, Na₂O, MnO, CaO, Cu, etc.

3. The mechanism and technology for inhibiting methane production in paddy as claimed in claim 1, wherein the composition and weight percentage of the far-infrared natural mineral base material are: silicon dioxide (SiO₂) 42˜52%, iron oxide (Fe₂O₃) 11˜13%, manganese dioxide (MnO₂) 4˜7%, calcium oxide (CaO) 2˜4%, zirconium dioxide (ZrO₂) 2˜4%, alumina (Al₂O₃) 2˜4%, zinc oxide (ZnO) 1˜3%, potassium oxide (K₂O) 3˜4%, magnesium oxide (MgO) 1˜3%, cobalt oxide (CoO) 1˜4%, pulverized fuel ash 9˜13%, coal powder 5%, titanium dioxide (TiO₂) 1˜2%, cerium oxide (CeO₂) 0.5˜0.8%, and lanthanum oxide (La₂O₃) 0.1˜0.5%; and make its far-infrared radiation rate reach the characteristic value of more than 87.9%.
